(19) United States
(12) Patent Application Publication
(10) Pub. No.: US 2006/0237034 A1
(43) Pub. Date: Oct. 26, 2006

(54) Process for recycling components of a PEM fuel cell membrane electrode assembly

(76) Inventors: Lawrence Shore, Edison, NJ (US); Arthur Bruce Robertson, Greenbelt, MD (US); Holly Sue Shulman, Schenectady, NY (US); Morgana Lynn Fall, New Paltz, NY (US)

Correspondence Address: BASF CATALYSTS LLC, 101 WOOD AVENUE, ISELIN, NJ, 08830, US

(21) Appl. No.: 11/110,406

(22) Filed: Apr. 20, 2005

(51) Int. Cl. B08B 7/04

(52) U.S. Cl. 134/10

(57) ABSTRACT

The membrane electrode assembly (MEA) of a PEM fuel cell is recycled by contacting the MEA with a lower alkyl alcohol solvent which separates the membrane from the anode and cathode layers of the assembly.

This invention was made with Government support under Cooperative Agreement No. DE-FC36-03GO13104 awarded by the United States Department of Energy. The Government has certain rights in the invention.

### FIELD OF THE INVENTION

The present invention is directed to a process for recycling components of a PEM fuel cell membrane electrode assembly.

### BACKGROUND OF THE INVENTION

Fuel cells convert a fuel and an oxidizing agent, which are locally separated from one another at two electrodes, into electricity, heat and water. Hydrogen or a hydrogen-rich gas can be used as the fuel, oxygen or air as the oxidizing agent. The process of energy conversion in the fuel cell is characterized by a particularly high efficiency. The compact design, power density, and high efficiency of polymer electrolyte membrane fuel cells (PEM fuel cells) make them suitable for use as energy converters, and for these reasons PEM fuel cells in combination with electric motors are gaining growing importance as an alternative to conventional combustion engines.

The hydrogen/oxygen type fuel cell relies on anodic and cathodic reactions which lead to the generation and flow of electrons and electrical energy as a useful power source for many applications. The anodic and cathodic reactions in a hydrogen/oxygen fuel cell may be represented as follows:
H₂→2H⁺+2e⁻(Anode)
1/2 O₂+2e⁻→H₂O (Cathode)

Each PEM fuel cell unit contains a membrane electrode assembly positioned between bipolar plates, also known as separator plates, which serve to supply gas and conduct electricity. A membrane electrode assembly (MEA) consists of a polymer electrolyte membrane, both sides of which are provided with reaction layers, the electrodes. One of the reaction layers takes the form of an anode for oxidizing hydrogen and the second reaction layer that of a cathode for reducing oxygen. Gas distribution layers made from carbon fiber paper or carbon fiber fabric or cloth, which allow good access of the reaction gases to the electrodes and good conduction of the electrical current from the cell, are attached to the electrodes. The anode and cathode contain electrocatalysts, which provide catalytic support to the particular reaction (oxidation of hydrogen and reduction of oxygen respectively). The metals in the platinum group of the periodic system of elements are preferably used as catalytically active components. Support catalysts are used in which the catalytically active platinum group metals have been applied in highly dispersed form to the surface of a conductive support material. The average crystallite size of the platinum group metals is between around 1 and 10 nm. Fine-particle carbon blacks have proven to be effective as support materials. The polymer electrolyte membrane consists of proton conducting polymer materials. These materials are also referred to below as ionomers. A tetrafluroethylene-flurovinyl ether copolymer with acid functions, particularly sulfuric acid groups, is preferably used. A material of this type is sold under the trade name Nafion® by E.I. DuPont, for example. Other ionomer materials, particularly fluorine-free examples such as sulfonated polyether ketones or aryl ketones or polybenzimidazoles, can also be used, however.

Fuel cells have been pursued as a source of power for transportation because of their high energy efficiency (unmatched by heat engine cycles), their potential for fuel flexibility, and their extremely low emissions. Fuel cells have potential for stationary and vehicular power applications; however, the commercial viability of fuel cells for power generation in stationary and transportation applications depends upon solving a number of manufacturing, cost, and durability problems.

One of the most important problems is the cost of the proton exchange catalyst for the fuel cell. The most efficient catalysts for low temperature fuel cells are noble metals, such as platinum, which are very expensive. Some have estimated that the total cost of such catalysts is approximately 80% of the total cost of manufacturing a low-temperature fuel cell.

In a typical process, an amount of a desired noble metal catalyst of from about 0.5-4 mg/cm² is applied to a fuel cell electrode in the form of an ink, or using complex chemical procedures. Such methods require the application of a relatively large load of noble metal catalyst in order to produce a fuel cell electrode with the desired level of electrocatalytic activity, particularly for low temperature applications. The expense of such catalysts makes it imperative to reduce the amount, or loading, of catalyst required for the fuel cell. This requires an efficient method for applying the catalyst.

In recent years, a number of deposition methods, including rolling/spraying, solution casting/hot pressing, and electrochemical catalyzation, have been developed for the production of Pt catalyst layers for PEM fuel cells.

In the case of hydrogen/oxygen fuel cells, some improvements in catalyst application methods have been directed towards reducing the amount of costly platinum catalyst in formulations. Development of compositions, for example, was achieved by combining solubilized perfluorosulfonate ionomer (Nafion®), support catalyst (Pt on carbon), glycerol and water. This led to the use of low platinum loading electrodes. The following publications teach some of these methods for hydrogen/oxygen fuel cells: U.S. Pat. No. 5,234,777 to Wilson; M. S. Wilson, et al, J. App. Electrochem., 22 (1992) 1-7; C. Zawodzinski, et al, Electrochem. Soc. Proc., Vol. 95-23 (1995) 57-65; A. K. Shukla, et al, J. App. Electrochem., 19(1989) 383-386; U.S. Pat. No. 5,702,755 to Messell; U.S. Pat. No. 5,859,416 to Mussell; U.S. Pat. No. 5,501,915 to Hards, et al.

To reduce dependency on the importation of oil, it has been suggested that the U.S. economy be based on hydrogen as opposed to hydrocarbons. The current atmosphere surrounding the hydrogen economy is supported in part by the success of the PEM fuel cell. As previously said, a primary cost relative to the manufacturer of PEM fuel cells is the noble metal, such as platinum, used as the catalytic electrodes. Importantly, the Nafion® membrane is also a relatively expensive material and contributes to the cost of the fuel cell stack. Typically, the average life of a fuel cell is about one year. Pinholes in the membrane and catalyst deactivation are some causes which reduce the effectiveness and, thus, useful life of the PEM fuel cell.

Recycling of the membrane electrode assembly, which typically contains a core of Nafion® membrane and the platinum/carbon electrodes coated on either side thereof, can address several of the cost issues related to manufacture and use of the PEM fuel cell. First, recovery of the platinum catalyst for reuse is important to meeting the world demand for the metal, and helping to maintain a reasonable price for the metal. Current commercial recovery of platinum from an MEA involves the combustion of the membranes and the processing of the ash. This mechanism is useful because it generates an ash that can be assayed for the purposes of commercial exchange. Unfortunately, there are two disadvantages with this prior process. First, ignition of the fluoropolymeric Nafion® membrane and the PTFE used often in the gas diffusion layers yields HF gas, which is corrosive and hazardous to health. Discharges of HF gas are highly regulated, and even with scrubbing of the gas, furnace throughput is constrained because of residual HF. Secondly, the burning of the Nafion® membrane destroys an expensive, value-added material.

Alternative processes have been proposed for MEA recycling. These processes do not address the issue of recycling to the extent of the present invention. For example, one process uses a fusion process to recover the precious metal from the MEA. A shredded MEA is processed in a flux containing calcium salt. This sequesters the liberated HF as CaF. However, the value of the MEA membrane is destroyed. Another process dissolves the MEA membrane and proposes to recast the membrane film and re-use the recovered electrode catalysts. Experience has shown that the physical properties of the membrane change during aging. Recasting a film with lower molecular weight polymer may result in a membrane with different properties than one made with virgin polymer.

Accordingly, it would be useful to provide an alternative process for recycling the membrane electrode assembly of a PEM fuel cell whereby the precious metal is recovered in high yield and the Nafion® or other fluoropolymeric membrane is completely recovered for potential recycling. Such a process in which there are no serious environmental issues such as the formation of HF gas can be operated with low-energy utilization, and whereby the process facilitates a commercial exchange based on the assay of the recovered precious metal would aid in promoting the hydrogen economy.

### SUMMARY OF THE INVENTION

It has now been found that lower alkyl alcohols, including mixtures of such alcohols with varying amounts of water, can disrupt the bond between the fluorocarbon-containing ionomer membrane and the attached Pt/carbon catalyst layers to allow separation of the intact membrane film from the Pt catalyst layers. Thus, recovery of the membrane for plastics recycling and recovery of the noble metal in the catalytic layer can be achieved without combustion of the membrane electrode assembly and formation of HF gas. It has been found that for the three-layer membrane assembly, made up of anode, membrane, and cathode, loss of adhesion between the membrane and the catalyst layers is followed by dispersal of the catalyst layers in the alcohol solvent. With a five-layer membrane, GDL/anode/membrane/cathode/GDL, the membrane separates from the exterior bilayers and facilitates subsequent recovery of the individual layers, including the noble metal catalyst, again, without combustion of the assembly.

### BRIEF DESCRIPTION OF THE DRAWINGS

The FIGURE illustrates a proposed apparatus which can be used in a process to recycle a PEM fuel cell membrane electrode assembly.

### DETAILED DESCRIPTION OF THE INVENTION

The present invention is directed to a method of delaminating a PEM fuel cell membrane electrode assembly utilizing lower alcohols or lower alcohol/water mixtures, and without the need to combust the membrane electrode assembly to recover a noble metal-ladened ash. The invention is particularly useful for three-layer membrane electrode assemblies in which a perfluorocarbon ionomer membrane is placed between an anode and cathode, typically formed of a noble metal such as platinum supported on carbon particles. Membrane electrode assemblies containing a five-layer assembly in which gas diffusion layers are placed in the assembly can also be delaminated and the precious metal in the electrodes recovered by the method of the present invention.

In the five-layer membrane electrode assemblies, gas diffusion-layers (GDLs) are placed on opposite ends of the respective electrodes. GDLs are typically carbon paper or carbon fiber structures known in the art. Often the GDLs contain a fluorocarbon to impart hydrophobicity. For example, Taniguchi et al, U.S. Pat. No. 6,083,638, discloses a fibrous carbon substrate pretreated with a fluororesin which is baked at 360° C., followed by treatment with particulate dispersions of hydrophobic and hydrophilic polymer to form discrete channels which are hydrophobic and hydrophilic. Isono et al, EP 1 063 717 A2, discloses a fibrous carbon substrate treated with a high temperature fluoropolymer in aqueous dispersion in such a manner as to exhibit a gradient in hydrophobicity in a direction normal to the direction of ion transport through the cell. The fibrous carbon substrate is further treated with a mixture layer comprising the same aqueous dispersion, and exhibiting a similar gradient in hydrophobicity. The entire structure is subject to heating to 380° C. to coalesce the polymer.

Dirven et al, U.S. Pat. No. 5,561,000, discloses a bilayer structure in which a fine pore layer consisting of PTFE and carbon is deposited by coating onto a PTFE-treated carbon paper or fabric.

The structures of the three-layer and five-layer MEAs are well known in the art. The particular methods of making such assemblies are also known and do not form a critical feature of the invention. Methods of manufacture, however, may affect the types of solvents used and the time of treatment. It has been found for five-layer MEAs, in particular, the method of manufacture of the MEA may affect how the GDLs are removed from the assembly.

The MEAs to be recycled in accordance with this invention contain fluorocarbon-containing ionomer membranes known in the art. In particular, fuel cells which contain perfluorosulfonate membranes such as Nafion® from Dupont can be readily treated in accordance with the teachings of the invention. Examples of perfluorosulfonate ionomers which can be used for membranes in the PEM fuel cells, and the, membrane electrode assemblies which can be treated in accordance with the present invention are disclosed in U.S. Pat. Nos. 4,433,082 and 6,150,426, assigned to E.I. Dupont de Nemours and Co., as well as U.S. Pat. No. 4,731,263, assigned to Dow Chemical Co, each of which U.S. Patent is herein incorporated by reference in its entirety. Other fluorocarbon-containing ionomers such as those containing carboxylate groups are being marketed and can be treated in accordance with this invention.

In accordance with this invention, the membrane electrode assembly is contacted with a solvent composed of at least one lower alkanol, preferably mixed with water. It has been found that the ratio of alcohol to water and the selection of the alcohol is dependent on whether or not the membrane is aged and whether or not boiling is used in GDL separation. In the case of membranes that have been aged, a alcohol-poor solvent mixture may be used; otherwise the membrane may disintegrate. An alcohol-pool solvent may be considered as an alcohol and water solvent containing less than 30 wt % alcohol, however, less than 25 wt % alcohol is also exemplified.

Upon contact with the solvent, it has been found that the fuel cell-membrane separates and is otherwise stripped from the anode and cathode layer. The membrane is removed intact and can be processed in a manner known for plastic recycling. The removal of the membrane allows recovery of the noble metal in the cathode and anode, which often remain intact or in fine particles (more than 90% of the particles <50 microns) or coarse particles (greater than 50 microns) of carbon, which contains the supported noble metal catalyst. It is preferred that the catalyst layer (the anode and cathode) remain intact, or at least in coarse particles. If separated as fine particles that readily disperse in the solvent, recovery of precious metal is made more difficult. The cathode and anode material containing the noble metal such as platinum can be fully recovered and the noble metal content refined therefrom. Membrane electrode assemblies containing gas diffusion layers can also be contacted with a lower alkanol-containing solvent, causing the gas diffusion layers and the membrane layers to separate from the catalyst layers, again allowing recovery of the catalyst without the need for combusting the membrane electrode assembly first into ash before recovery.

By the term “contacting,” it is meant primarily that the membrane electrode assembly be immersed or suspended in the alcohol or alcohol/water solvent. Agitation of the solvent may be useful in providing uniform mixtures of the alcohol and water and in decreasing the time needed for separation of the membrane from the catalyst layers. It is also possible to continuously contact the MEA with a flowing stream of solvent such as a mist or more concentrated liquid spray. Further, the MEA can be maintained in an alkyl alcohol solvent vapor stream, which may include steam for a time sufficient for the membrane to strip from the catalytic layers.

The solvent which is used in the present invention will comprise at least one C₁ to C₈ alkyl or isoalkyl alcohol. Mixtures of two or more such lower alkyl alcohols can also be used. It has been found that the addition of 5 up to 95% by weight water facilitates the separation process. Water alone has been found insufficient to separate the membrane from the catalytic anode and cathode layers. Preferably, the alcohol will be a C₄ to C₆ alkyl alcohol, as the lower alcohols such as methanol, ethanol, and isopropanol have low flash points. However, C₁ to C₃ alkyl alcohols, including mixtures of same, are effective for membrane separation. Additional water contents relative to the mixture of 10 to 90% by weight are useful, including water contents of 10 to 50 wt. %. Alkanols higher than 6 carbon atoms may not form a miscible mixture with water even under agitation, and may not be as useful. Contact time may vary depending on the particular assembly and the particular solvent utilized, but typically at least 10 seconds and up to 10 minutes contact time is sufficient to cause separation of the membrane from the catalyst layers. Preferably, times of 30 seconds to 3 minutes are achievable with the right set of parameters.

As prepared, the carbon catalyst particles may be combined with Nafion® ionomer. The process can be adjusted to reduce the residual ionomer content of the recovered carbon particle. The precious metal content of the carbon particle may be recovered by buring the recovered material. This can facilitate a commercial settlement based on the weight of the ash and the assay of the ash. Alternatively, the precious metal may be leached out of the carbon. A commercial settlement could then be achieved using the volume of leachate and the assay of the leachate. Both the leaching process and combustion may be accelerated with heating. In the case of the former, both heat and pressure may be combined to assist in the dissolution of the precious metals. Commmercial methods of precious metal recycling can then be employed to purify the metal.

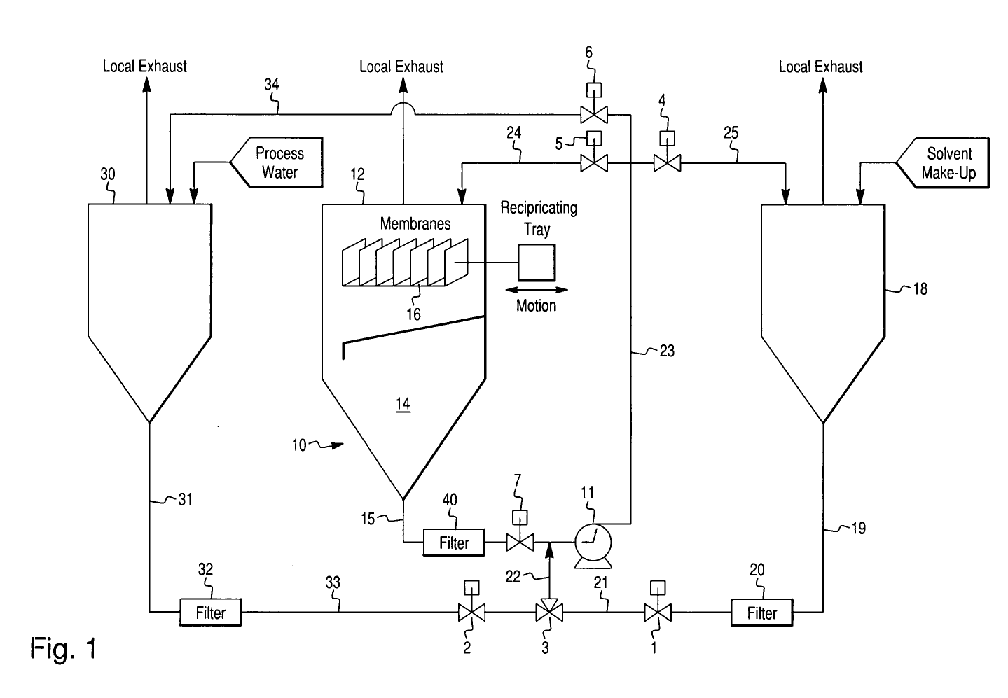

FIG. 1 shows a proposed apparatus and proposed method for recycling a PEM fuel cell membrane electrode assembly in accordance with the present invention. Referring to the FIGURE, a reaction tank 10 containing an upper chamber 12, into which the MEAs are suspended, and a lower chamber 14 for the catalyst recovery is provided. The upper chamber 12 may contain a reciprocating tray 16 to hold and support the membrane electrode assemblies (not shown). The reaction tank 10 is filled with solvent such as from alkanol storage tank 18 via line 19, filter 20, and lines 21, 22, 23, and 24 and pump 11. The alcohol solvent can be cycled back to storage 18 via line 25. Water storage tank 30 can deliver water to reaction tank 10 via line 31, filter 32, and lines 33, 22, 23, and 24, and pump 11. Water can be cycled back to tank 30 via line 34. Depending on the operation of the valves 1, 2, 3, 4, 5, 6, and 7, alcohol or a mixture of alcohol and water can be supplied to reaction tank 10, and the solvents recycled to the appropriate storage or to reaction tank 10. Once reaction tank 10 is filled with the appropriate solvent, the reciprocating tray 16 supporting the membrane electrode assemblies is put in motion to cause agitation between the MEAs and solvent. Although not shown, other agitating means may be included in the upper chamber 12. For example, such means include stirring means such as blades or rods, as well as means to provide some type of sonic vibration to the solvent. After the desired period of time, the solvent is pumped from the bottom of lower chamber 14 via line 15 and passed through a filter 40, and then pumped via pump 11 and lines 23 and 24 back into upper chamber 12. After repeating the agitating step, the solvent is drained again and recycled to the upper chamber 12 of reaction tank 10. This cycle is repeated until the solvent is free of particulate matter. Once the cycle is complete the MEA membrane can be recovered from the reciprocating tray 16. The reusability of the MEA membrane may be contingent on the degree of aging it has endured. However, it is expected that the molecular weight of the MEA membrane may be reduced with aging, and reuse of the polymer in the MEA application may not be preferred. An alternative use for the recovered MEA membrane might be as a component of a solid catalyst. The process can be monitored using an instrument such as nephelometer, which can measure the turbidity of the solvent, such as in line 23.

The carbon particles containing the supported noble metal catalyst are collected on the filter 40. After the filtration is completed, the filter cake can be dried, weighed, and sampled. The precious metal content of the sample is directly related to the content of a precious metal in the lot of extracted MEAs, and can be recovered by conventional refining techniques.

The process has two variations. In the first case, the MEAs are inserted in reaction tank 10 as received, and include the GDL (gas diffusion layer). In this case, agitation or application of ultrasound can be applied to separate the catalyst layer from the GDL and to minimize the loss of the catalyst particles in the pores of the GDL. A sorting mechanism would be required to separate the GDL from the Nafion® sheets when the upper chamber 12 is disassembled and contents removed. In the second case, the GDL, which is pressed or adhered onto both sides of the MEA, is physically stripped from the MEA prior to solvent treatment. Separation of the GDL from the core can be assisted by exposing the 5-layer MEA to steam or boiling water. Although the GDL is impregnated with PTFE, the carbon fibers of the GDL have recycling value. It has been shown that the PTFE can be removed using microwave heating, although HF will be evolved. Furthermore, it is expected that there will be a small amount of carbon catalyst on the GDL that has been transferred by the contact under pressure. The precious metal content of the GDL can be recovered in three ways:
1. The GDL can be exposed to solvent in a separate apparatus and the solvent filtered as described above.
2. Assuming minimal precious metal content, the GDL can be treated with an oxidizing acid, such as aqua regia, to dissolve primarily the Pt present, and the solution can be assayed for precious metal content prior to recovery activities.
3. The GDL or portions thereof can be burned and the ash assayed. This option reintroduces the issue of HF formation because of the presence of PTFE, another fluoropolymer, in the GDL, and may require advanced processes for successful implementation.

It has been found that the method of manufacturing the MEA, in particular, if GDLs are present may affect how the GDLs need to be removed. For example, in particular, with certain unused, but scrap MEAs which contain GDLs, the assemblies need to be initially treated with steam or boiling water to strip the gas diffusion layers from the catalytic anode and cathode layers. MEAs which have been used to create power appear to be more easily separated even if gas diffusion layers are present.

### EXAMPLES

### Example 1

It has been found that isopropanol mixed with various amounts of water disrupted the bond between Nafion® and the attached carbon catalyst layers. In the case of a three-layer membrane assembly, made up of anode, Nafion® and cathode, loss of adhesion between the membrane and catalyst layers is followed by dispersal of the catalyst layers. With the five-layer membrane (GDL/anode/Nafion®/cathode/GDL), the Nafion® separates from the exterior bilayers, and facilitates subsequent harvesting of the individual components. Table 1 represents the removal of the Nafion® membrane using isopropanol/water mixtures, water alone, ammonia, and an ammonia/water mixture. The MEA was immersed in the volume of solvent shown.

TABLE 1

| | DI | Isopropanol | Isopropanol | Isopropanol | Ammonia | | Time | |
|---|---|---|---|---|---|---|---|---|
| Sample # | H₂O | 35% | 70% | 91% | (N/A) | Separation | approx | |
| 1 | 20 ml | | | | | No | N/A | |
| 2 | | 20 ml | | | | Yes | 12 | hrs |
| 3 | | | 20 ml | | | Yes | 0.5 | hr |
| 4 | | | | 20 ml | | Yes | 0.5 | hr |
| 5 | | | | | 20 ml | No | N/A | |
| 6 | 10 ml | | | | 10 ml | No | N/A | |
| 7 | | | 20 ml | | | Yes | 0.5 | hr |
| 8 | | | | 20 ml | | Yes | 0.5 | hr |

Agitation

| | | | | |
|---|---|---|---|---|
| 9 | 20 ml | Yes | 1 | min |
| | | | 38 | sec |
| 10 | 20 ml | Yes | 30 | sec |
| 11 | 20 ml | Yes | 25 | sec |
| 12 | 20 ml | Yes | 28 | sec |

### Example 2

Membrane stripping experiments were performed using ultrasonic or hand agitation with different concentrations of methanol, ethanol, isopropanol, and butanol, See Table 2. The purpose of these experiments was to document the time and the manner in which (if at all) the black layers were stripped from the Nafion® membrane. High and low molecular weight alcohols were explored. The sample size used was 1 cm² in 20 ml of solvent.

The 3-layer and 5-layer membranes were successfully separated from the black catalyst layers using methanol, ethanol, isopropanol, and butanol as solvents.

TABLE 2

| | | | Run 1 | Run 2 | | Average | Notes | |
|---|---|---|---|---|---|---|---|---|
| Alcohol | Concentration | Agitation | (min) | (min) | STD | (min) | Run 1 | Run 2 |
| 3 Layer | | | | | | | | |
| Ethanol | 35% | Hand | — | | | | 1 BL, 1C, FBP | |
| Ethanol | 35% | Ultrasonic | — | | | | 1 BL, 1C | |
| Isopropyl | 35% | Hand | 4:14 | | | 4:14 | 1 BL, 1C, CBP, GR | |
| Isopropyl | 35% | Ultrasonic | 5:00 | | | 5:0 | 1 BL, 1S, FBP | |
| Butanol | 35% | Hand | 2:20 | | | 2:20 | 1 BL, 1C, CBP, GR | |
| Butanol | 35% | Ultrasonic | 3:30 | | | 3:30 | 1BL, 1C, FBP | |
| Methanol | 35% | Hand | — | | | | 1 BL, 1C | |
| Methanol | 35% | Ultrasonic | — | | | | 1 BL, 1C, FBP | |
| 5 Layer | | | | | | | | |
| Ethanol | 35% | Hand | — | | | | 3 BL | |
| Ethanol | 35% | Ultrasonic | — | | | | 4 BL>10 min | |
| Isopropyl | 35% | Hand | 6:35 | 2:41 | 2:45 | 4:38 | 4 BL, 2C | 4 BL, 2C, GR |
| Isopropyl | 35% | Ultrasonic | 11:30 | 2:18 | 6:30 | 6:54 | 4 BL, 1C, 1S, FBP | 4 BL, 2C |
| Butanol | 35% | Hand | 1:02 | 1:01 | 0:00 | 1:01 | 4 BL, 2C | 4 BL, 2C, GR |
| Butanol | 35% | Ultrasonic | 2:30 | 2:07 | 0:16 | 2:18 | 4 BL, 2S | 4 BL, 2S, GR |
| Methanol | 35% | Hand | — | | | | 3 BL | |
| Methanol | 35% | Ultrasonic | — | | | | 3 BL | |
| 3 Layer | | | | | | | | |
| Ethanol | 100% | Hand | 2:22 | 2:30 | 0:5 | 2:26 | 1 BL, 1C, CBP, GR | |
| Ethanol | 100% | Ultrasonic | 3:40 | | | 3:40 | 1 BL, 1S, FBP | |
| Isopropyl | 70% | Hand | 1:20 | | | 1:20 | 1 BL, 1S, CBP | |
| Isopropyl | 70 | Ultrasonic | 2:30 | | | 2:30 | 1 BL, 1S, FBP | |
| Butanol | 100% | Hand | 4:50 | 7:00 | 1:31 | 5:55 | 1 BL, 1C, CBP | |
| Butanol | 100% | Ultrasonic | 3:10 | | | 3:10 | 1 BL, 1C, CBP | |
| Methanol | 100% | Hand | 1:44 | 3:40 | 1:22 | 2:42 | 1 BL, FBP | |
| Methanol | 100% | Ultrasonic | 3:10 | | | 3:10 | 1BL, FBP | |
| 5 Layer | | | | | | | | |
| Ethanol | 100% | Hand | 3:25 | | | 3:25 | 4 BL, 2C | |
| Ethanol | 100% | Ultrasonic | 5:21 | | | 5:21 | 4 BL, 2S | |
| Isopropyl | 70% | Hand | 2:03 | 0:45 | 0:55 | 1:24 | 4 BL, 2S | 4 BL, 2S, FBP |
| Isopropyl | 70% | Ultrasonic | 3:30 | 4:36 | 0:46 | 4:03 | 4 BL, 2S | 4 BL, 2S, FBP |
| Butanol | 100% | Hand | 4:16 | | | | 4 BL, 2C | |
| Butanol | 100% | Ultrasonic | 7:57 | | | | 4 BL, 2C | |
| Methanol | 100% | Hand | 1:09 | | | | 4 BL, 2C | |
| Methanol | 100% | Ultrasonic | 1:50 | | | | 4 BL, 2C | |

Key
BL Black Layer
CBP Coarse Black Particles
FBP Fine Black Particles
C Curled
S Shreaded
GR Glue Residue
Size = 1 cm²
Solvent = 20 ml
— donotes did not come apart or >> 10 min

### Example 3

Experimental pre-treatment of MEA membranes were performed for removal of the GDL layer by boiling the MEA in water or hand stripping the GDLs. Different concentrations of isopropanol, 2-butanol and n-butanol, See Tables 3-5, were used to separate the membrane from the cathode and anode. The purpose of these experiments was to document the percentage of platinum recovered from new (See Tables 3 and 4), and used (See Table 5) MEA membranes using different methods for GDL removal and different concentrations of alcohol. The sample size used was 1 in², and the solvent volume was variable, as described below.

Almost no difference in recovery of platinum was seen between differing GDL removal steps, or between different solvents, when treating used MEA membranes, See Table 5. However, differences in the method of removing the GDL layer had a major impact on subsequent processing of new MEA membranes, See Tables 3 and 4.

TABLE 3
Pt recovered from new MEA membrane, supplier 1

| GDL | | % Pt recovered |
|---|---|---|
| Pretreatment | Solvent | from solvent |
| Boiled | 100 mL of 70% | 67 |
| | isopropanol | |
| | 100 mL of 70% 2- | 68 |
| | butanol | |
| | 100 mL of 70% n- | 79 |
| | butanol | |
| Hand-stripped | 100 mL of 70% | 99 |
| | isopropanol | |
| | 100 mL of 70% 2- | 96 |
| | butanol | |
| | 100 mL of 70% n- | 95 |
| | butanol | |

TABLE 4
Pt recovered from new MEA membrane, supplier 2

| | | % Pt recovered from |
|---|---|---|
| GDL Pretreatment | Solvent | solvent |
| Boiled | 40 mL of 25% | 55 |
| | isopropanol | |
| | 40 mL of 25% 2-butanol | 96 |
| | 40 mL of 25% n-butanol | 58 |
| Hand-stripped | 40 mL of 25% | 97 |
| | isopropanol | |
| | 40 mL of 25% 2-butanol | 99 |
| | 40 mL of 25% n-butanol | 99 |

TABLE 5
Pt recovered from used MEA membrane

| | | % Pt recovered from |
|---|---|---|
| GDL Pretreatment | Solvent | solvent |
| Boiled | 40 mL of 25% | 94 |
| | isopropanol | |
| | 35 mL of 15% 2-butanol | 95 |
| | 40 mL of 25% n-butanol | 96 |
| Hand-stripped | 40 mL of 25% | 90 |
| | isopropanol | |
| | 35 mL of 15% 2-butanol | 99 |
| | 40 mL of 25% n-butanol | 98 |

### Example 4

Pre-treatment experiments of 5-layer MEAs with intact GDL were performed using different concentrations of isopropyl alcohol, and n-butanol, See Tables 6 and 7. The purpose of these experiments was to determine the effect of pre-treatment on the GDL layer. The sample size used was 1 in² in 20 ml of solvent, and the solvent volume was variable, estimated at 20 to 30 mL.

New 5-layer MEAs were difficult to process. However, used MEAs are more easily processed, even with alcohol-poor solvents, See Tables 6 and 7.

TABLE 6
Pre-treatment of new MEA with intact GDL.

| Solvent | Results |
|---|---|
| 70% isopropyl alcohol | Membrane swells and exposed edges |
| | disintegrate. GDL intact. |
| 100% n-butanol | Edge of membrane spreads and |
| | disintegrates. GDL intact. |
| 70% reagent alcohol (primarily | One GDL detaches, membrane |
| ethanol) | peelable from second GDL. |

TABLE 7
Pre-treatment of used MEA with intact GDL.

| Solvent | Results |
|---|---|
| 70% isopropyl alcohol | Instantaneous separation - coarse |
| | catalyst particles |
| 10% isopropyl alcohol | Layers separate in <1 min. Membrane |
| | peelable from one GDL |
| 35% n-butanol | Layers separate in 30 sec., massive |
| | swelling of membrane |
| 8% n-butanol | GDL's separate in <1 min. Membrane |
| | clean, swelling reduced. |

What is claimed is:

1. A process for recycling a membrane electrode assembly from a PEM fuel cell, said membrane electrode assembly comprising a fluorocarbon-containing ionomer film and supported noble metal catalyst coated on both sides of said film, said process comprising: contacting said membrane electrode assembly with a solvent containing at least one C₁ to C₈ alkyl alcohol for a time sufficient to separate said ionomer film from said supported noble metal catalyst, and recovering the separated supported metal catalyst in the form of an intact layer, or coarse particles.

2. The process of claim 1 wherein said alkyl alcohol is a C₃-C₆ alkyl alcohol.

3. The process of claim 1 wherein said alkyl alcohol is butanol.

4. The process of claim 1 wherein said solvent includes a mixture of said alcohol and water.

5. The process of claim 1 wherein said membrane electrode assembly is contacted with said solvent by immersing said membrane electrode assembly in a bath of said solvent.

6. The process of claim 1 wherein said supported noble metal catalyst comprises platinum on carbon.

7. The process of claim 1 wherein said membrane electrode assembly includes gas diffusion layers placed against each coating of supported noble catalyst and said gas diffusion layers are removed by mechanical means.

8. The process of claim 1 wherein said membrane electrode assembly includes gas diffusion layers placed against each coating of supported noble catalyst and said gas diffusion layers are removed by steam or boiling in water.

9. The process of claim 1 comprising filtering said solvent subsequent to separation of said ionomer film to recover said supported noble metal catalyst as a filter cake.

10. The process of claim 1 wherein said fluorocarbon-containing ionomer film is recovered after separation of said ionomer film from said noble metal catalyst.

11. A process for recycling a membrane electrode assembly from a PEM fuel cell, said membrane electrode assembly comprising a fluorocarbon-containing ionomer film and supported noble metal catalyst coated on both sides of said film, said process comprising: contacting said membrane electrode assembly with a solvent containing a mixture of water and at least one lower alkyl alcohol, said alcohol being present in the mixture in an amount of up to 30 wt %, for a time sufficient to separate said ionomer film from said supported noble metal catalyst, and recovering the separated supported metal catalyst in the form of an intact layer, or coarse particles.

12. The process of claim 11 wherein said alkyl alcohol is a C₃-C₆ alkyl alcohol.

13. The process of claim 11 wherein said alkyl alcohol is butanol.

14. The process of claim 11 wherein said membrane electrode assembly is contacted with said solvent by immersing said membrane electrode assembly in a bath of said solvent.

15. The process of claim 11 wherein said supported noble metal catalyst comprises platinum on carbon.

16. The process of claim 11 wherein said membrane electrode assembly includes gas diffusion layers placed against each coating of supported noble catalyst and said gas diffusion layers removed.

17. The process of claim 16 wherein said gas diffusion layers are removed by mechanical stripping.

18. The process of claim 16 wherein said gas diffusion layers are removed by steam or boiling in water.

19. The process of claim 11 comprising filtering said solvent subsequent to separation of said ionomer film to recover said supported noble metal catalyst as a filter cake.

20. The process of claim 11 wherein said fluorocarbon-containing ionomer film is recovered after separation of said ionomer film from said noble metal catalyst.
